(19) United States
(12) Patent Application Publication
(10) Pub. No.: US 2025/0342727 A1
(43) Pub. Date: Nov. 6, 2025

(54) IDENTIFYING UNAUTHORIZED USE OF VISUAL DIGITAL CONTENT

(71) Applicant: WEIR AI, Menlo Park, CA (US)

(72) Inventors: Tal Hassner, Menlo Park, CA (US); Gary McCoy, Menlo Park, CA (US)

(21) Appl. No.: 19/078,132

(22) Filed: Mar. 12, 2025

Related U.S. Application Data
(60) Provisional application No. 63/641,929, filed on May 2, 2024.

(51) Int. Cl. G06V 40/20; G06T 5/70; G06V 40/16

(52) U.S. Cl. CPC G06V 40/25; G06T 5/70; G06V 40/165

(57) ABSTRACT

The system receives data indicating an individual and processes the data to isolate the individual and to enhance data quality. The system extracts a first multiplicity of key features of the data, which tend to uniquely identify the individual. The system compares, using artificial intelligence, the first multiplicity of key features associated with the data to a second multiplicity of key features associated with a user to determine whether the data indicates the user. Upon determining that the data indicates the user, the system retrieves from a datastore a rule associated with the second multiplicity of key features and determines whether the rule permits use of the data indicating the individual. Upon determining that the rule associated with the second multiplicity of key features does not permit use of the data indicating the individual, the system sends an indication that the rule does not permit the use.

### CROSS-REFERENCE TO PRIOR RELATED APPLICATIONS

This U.S. Utility Patent application claims priority to and the benefit of U.S. Provisional Patent Application No. 63/641,929, filed May 2, 2024, which is incorporated herein in its entirety by this reference.

### FIELD OF SYSTEM

The disclosed system relates to the field of computer vision and machine learning. More particularly, it relates to identifying unauthorized use in digital media such as images or video.

### BACKGROUND

Facial recognition systems are employed throughout the world today by governments and private companies. Their effectiveness varies, and some systems have previously been scrapped because of their ineffectiveness. The use of facial recognition systems has also raised controversy, with claims that the systems violate citizens' privacy, commonly make incorrect identifications, encourage gender norms and racial profiling, and do not protect users' privacy because the systems may not protect important biometric data.

### BRIEF DESCRIPTION OF THE DRAWINGS

Reference will now be made, by way of example, to the accompanying drawings, which show example embodiments of the present application, and in which:

FIG. 1 shows the identity recognition system.

FIG. 2 shows detailed components of the system.

FIG. 3 is a flowchart of a method to identify a person in a visual representation containing multiple people while preserving privacy.

FIG. 4 shows an identity recognition system, such as a face recognition system, when an individual allows to be recognized.

FIG. 5 shows an identity recognition system, such as a face recognition system, that can isolate individuals from an image containing multiple people.

FIGS. 6A-6B show a flowchart of a method to perform identity classification when not all participants have agreed to be identified.

FIG. 7 shows a system to identify unauthorized use of visual digital content via whole-image embedding representations.

FIGS. 8A-8B are a flowchart of a method to identify unauthorized use of digital content.

FIG. 9 shows a system to identify unauthorized use of digital content.

FIG. 10 is a flowchart of a method to identify unauthorized use of digital content.

FIG. 11 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the system are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Standard face recognition pipelines share similar designs where a single photo undergoes several key stages with minor variations in their order. The same steps are applied to videos, typically by applying them to single frames with additional steps applied to aggregate information across frames implemented using any standard prototype generation method, possibly using various means of frame sampling.

Initially, a specialized identity localization component provides the locations of each person in the image. For instance, a face recognition system would start by detecting the locations of all the faces in the image, often using a face detection component, and obtaining for each face its 2D bounding box coordinates or alternative localization representations such as 6 degrees of freedom (6DoF) face pose, their variants, and alternatives. The image region presenting each person then undergoes individual processing, as described in the next paragraphs.

Per person, identity preprocessing is sometimes (optionally) applied to the image region associated with each person to aid subsequent recognition steps. This step can include geometric alignment in two-dimensions (2D) or three-dimensions (3D), cropping and scaling, photometric alignment such as color correction, image denoising, and other similar functions, their variants, and alternatives. For instance, in a face recognition system, this step often involves face alignment.

Processing continues using a dedicated deep network, often termed an identity embedding network or, in the context of face recognition systems, a face embedding network. This step generates a separate high-dimensional numeric representation of each identity detected in the media. This network is typically trained on large, specialized datasets containing example media of many people as well as labels representing each person's identity or similarity/dissimilarity (same/not-same identity) labels for image pairs. Other labeling variants or alternatives are also sometimes used in this context. In modern deep learning frameworks, these representations are often referred to as identity embeddings or, in the context of face recognition systems, as face embeddings. In earlier work, they were referred to as identity descriptors (similarly, face descriptors).

Identity embeddings serve as probes in a probe-gallery matching system: Identity embeddings are matched against the appearance representations of people who were previously enrolled (stored) in a gallery. The gallery is a database, or a subset of a database, containing visual media representations for people known to the system and whom the system is used to recognize. Gallery representations can be identity embeddings but are often identity templates (similarly, face templates), and each template is an aggregate of the appearance information of a single person as it appears in multiple images or viewing conditions. Matching a probe to a gallery item is typically performed using nearest neighbor techniques, approximate nearest neighbor techniques, their variants, or alternatives. The matching process assumes a definition of distances between these representations, such as L2, cosine, their variants, or alternatives. A match occurs if the distance between probe and gallery representations falls below some predetermined threshold, typically determined empirically. Upon matching, the known identity of the matched gallery item is assigned to the probe as the system's recognition result for this detected person in the input visual media.

Notably, aside from the initial identity localization stage, subsequent steps are applied individually to each person appearing in the input media, typically without context from the wider input media or other people appearing in it. Processing the input media, therefore, involves computation and storage that scales roughly linearly in the number of people appearing in the media. In particular, the system represents each detected person (e.g., each face bounding box in the context of a face recognition system) with its own individual embedding. Moreover, these steps are tailored specifically for identity recognition. Thus, if, for instance, this is a face recognition system, the components it comprises cannot trivially be applied to other image classification or recognition tasks. One reason for this is that the different machine learning models involved in these identity recognition systems must be trained on example media containing appearances of people with associated training labels representing their identities. This training makes these components tailored to the specific recognition tasks they were designed for. Moreover, a face recognition system, for instance, may also include components that are explicitly designed to capture face-specific information such as the geometry of the face or facial locations referred to as facial landmarks.

The disclosed system uses a single visual representation for recognizing the plurality of identities appearing in an input visual media and which has a fixed dimension, determined during system design, independently of the number of people appearing in a single image or frame of the visual media used as input to the system. By not isolating individual people in the image and encoding the images into numerical vectors in multidimensional space, the disclosed system protects the user's privacy. The disclosed system also analyzes visual information from across the image to recognize each of the people contained in that image. The disclosed system does not use components trained on specialized datasets containing example (training) images of people's appearances with associated training labels representing individual identities, identity similarities, facial geometries, facial locations, or any other information specific to the recognition of people.

The description and associated drawings are illustrative examples and are not to be construed as limiting. This disclosure provides certain details for a thorough understanding and enabling description of these examples. One skilled in the relevant technology will understand, however, that the system can be practiced without many of these details. Likewise, one skilled in the relevant technology will understand that the system can include well-known structures or features that are not shown or described in detail to avoid unnecessarily obscuring the descriptions of examples.

### Identity Classification in Visual Digital Content Based on Whole-Image Representations

Open world face recognition refers to either “1:1 verification” or “1:N recognition.” “Open world” means that the system is used to recognize people who were not known when the system was being trained and were not used to train or develop it.

“1:1 verification” refers to having two images, image1 and image2, containing faces and asking: yes/no is the face in both images of the same person or not (are they “same/not-same”)? This application refers to image1 and image2, jointly, as the “two sides” of 1:1 verification. When appropriate, this application refers to the two individuals appearing in image1 and image2 also as the “two sides.”

“1:N recognition” refers to having an image containing a face (referred to here as a “probe”) and a database of images (referred to here as a “gallery”) of N different people. Systems for 1:N recognition use 1:1 verification by running multiple 1:1 verifications, each time taking the probe and one of the gallery faces to ask whether the probe face is same/not-same as the gallery face. If 1:1 verification of the probe and any one of the gallery faces returns “same,” the system returns that gallery face's ID as the “recognition result”: the identity of the face in the probe.

“Image,” singular, can mean a set of images, frames in a video, etc. For instance, a 1:1 verification system may be used to compare two sets of images to answer whether the face appearing in one set is the same as the face appearing in the other. Such systems aggregate the images, their representations, or the outcome of the comparisons using standard methods to obtain a single same/not-same answer.

In existing systems, images are first processed using a “face detector” that identifies regions in an image containing a face, typically by positioning a box (a “bounding box”) around each face region. These systems then process each face region separately from the rest of the image and any other faces it may contain.

For each face, existing systems extract a representation, capturing the appearance of that face. To produce this representation, these systems use methods specifically designed to produce representations of facial appearances. These methods are referred to here as “face models” and the representations they produced are referred to as “face-specific representations.”

Some argue that using face models to extract face-specific representations from face regions is analogous to using forensic tools to take multiple fingerprints (or DNA, etc.) at a scene. In this analogy, existing face recognition systems are analogous to fingerprint identification. Based on this argument, cases where 1:1 verification is performed on images where one of the two sides did not provide authorization to be recognized are like obtaining fingerprints or DNA without permission and so may be in violation of various biometric regulations.

The previous and current technologies are designed to exercise an abundance of caution when processing images containing appearances of individuals who may not have given authorization.

The disclosed system represents an entire image, rather than each face separately, using methods that were trained on general image understanding tasks rather than face models. In the previous applications, we referred to these whole-image representations as whole-image embedding representations (WIER). A possible downside of this approach is that it may result in a significant drop in recognition accuracy.

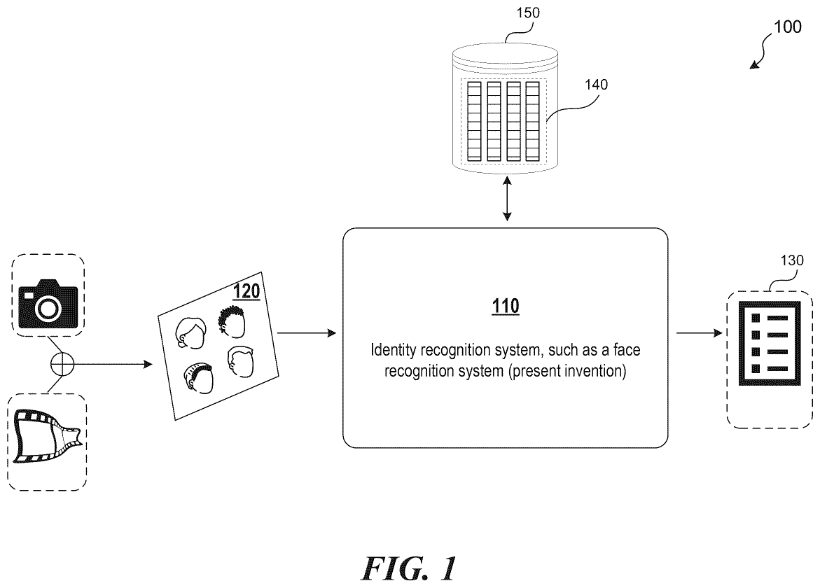

FIG. 1 shows the identity recognition system. The disclosed system 100 includes an identity recognition system 110, such as a face recognition system, which extracts from an input query image 120 an embedding vector that is WIER 130 and matches the embedding vector 130 to other whole-image embedding representations 140 stored in the database 150. The whole-image embedding representations 140 can represent enrolled users and can be aggregates collected from multiple images of each enrolled user.

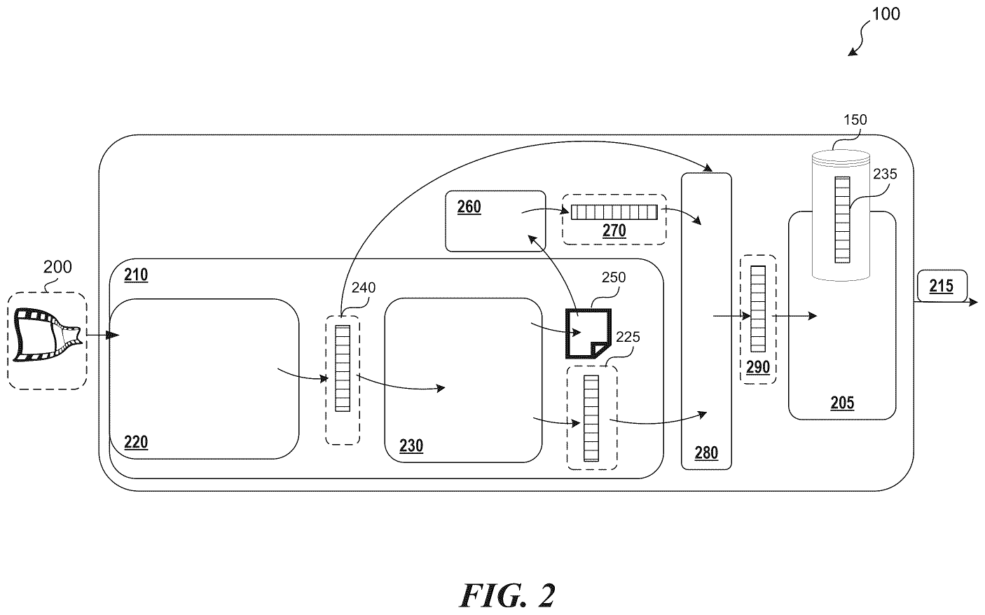

FIG. 2 shows detailed components of the system 100 in FIG. 1. The system 100 receives a visual representation 200, i.e., a visual medium such as an image, a video, a three-dimensional indication of geometry, etc. The system 100 includes a machine learning component 210, which processes the visual representation 200. The machine learning component 210 can include a two-stage process involving image feature extraction component 220 and text generation component 230.

Image feature extraction component 220 can be a machine learning module for extracting one or more types of image embedding vectors 240 representing the visual representation 200 as a whole rather than specific objects or people appearing in the visual representation. The visual representation 200 can represent multiple people and multiple objects, and a single image embedding vector 240 can represent multiple people and multiple objects. The component 220 can be Convolutional Neural Networks (CNN), such as VGG16 or ResNet68, trained on large datasets of images labeled for image classification tasks and/or regression tasks such as ImageNet, its variants, or alternatives, or more sophisticated networks such as the Contrastive Language-Image Pre-training (CLIP), its variants, and alternatives. Importantly, the example data used for training component 220 is not limited to faces or people and does not necessarily include names or other identity markers for people, if any people appear in the training data.

The representation, i.e. embedding vector 240, is then processed by a text generation component 230 that is implemented as a machine learning model such as a Recurrent Neural Network (RNN), transformer, their variants, or alternatives. Component 230 is trained on images and their corresponding textual descriptions to generate a text 250 that accurately describes the contents of the input image in human-understandable written language (e.g., English, Hanzi). The text generation component 230 is trained on images capturing a wide range of visual scenes, each image associated with its corresponding text descriptions, to learn how to generate texts that accurately describe the content of an input image.

In the system 100, training machine learning components 220, 230 is implemented either as separate, per model training, or end-to-end training. In the latter case, either or all models in these components are trained from scratch or fine-tuned after preliminary training. In the system 100, text 250 can be processed by a pre-trained machine learning model 260 that converts the text 250 from a human-readable text 250 to a semantic representation 270, which is also an embedding vector. Model 260 can be implemented as a Bidirectional Encoder Representations from Transformers (BERT), its variants, or alternatives.

Text generation model, or text generation component, 230 can produce intermediate representations 225 while processing its input 240. These representations are referred to as contextual embeddings 225. In the disclosed system 100, embedding vectors 240, 225, and 270 (or any subset of the three) are processed by a consolidation component 280 that combines the information they provide and produces a combined, whole-image embedding representation (WIER) 290. In other words, WIER 290 can be a combination of one or more embedding vectors 240, 225, and 270.

Consolidation component 280 can be implemented in various ways, including simple concatenation of its input vectors. Alternatively, consolidation component 280 can be implemented by training a machine learning network to combine the information captured by its input vectors into a single representation.

WIER 290 is then processed by a probe/gallery component (e.g. matching component) 205, which matches WIER 290 with WIER 140 in FIG. 1 extracted from images of enrolled individuals in a database 150. The matching component 205 can be implemented as nearest neighbor matching, approximate nearest neighbor matching, their variants, or alternatives, assuming any measure of vector-to-vector similarity, such as L2, cosine, their variants, or alternatives, and using a threshold to indicate a match.

In the disclosed system 100, WIER 140 for enrolled individuals can be aggregated into WIER templates capturing appearance information of multiple images previously submitted to the system and labeled as containing the same enrolled individual. An example implementation of this component is simple component-wise averaging of multiple WIER. Enrolled identities whose appearances are determined to match those of people appearing in the input are reported by a notification 215.

The machine learning models used as part of the image feature extraction component 220 and the text generation component 230 can be trained separately or jointly in an end-to-end manner. Another alternative is that one or more of these models can be pre-trained separately and then fine-tuned as part of end-to-end training.

In the disclosed system, the text 250 generated by the text generation component 230 are converted to semantic embeddings using off-the-shelf (pre-trained) models such as BERT, its variants, or alternatives.

In the disclosed system 100, one or more of the image embedding vectors 240, contextual embeddings 225, and semantic representation 270 produced while processing an input image 200, collectively referred to here as “intermediate representations,” can be combined using a consolidation component 280 into a single representation that the disclosed system refers to as WIER 290.

The consolidation component 280 can be implemented, for instance, as a simple concatenation of the intermediate representations, with or without normalization of their values, or, alternatively, by using a machine learning method, such as a deep neural network that is trained to combine intermediate representations into a single representation.

In the disclosed system 100, an enrolled individual provides one or more images or other available media that is likely to capture their appearance. WIER 140 are extracted for each image or video frame in this media and then stored in a database 150 as individual WIERs or, alternatively, as an additional aggregate representation termed a WIER template 235 or WIER prototype. An implementation of this template (prototype) generation component can be a simple element-wise averaging of multiple WIER, their variants, or alternatives. These appearances are stored alongside the person's enrolled identification.

In the disclosed system 100, when an input media 200 is presented to the system, a WIER 290 is extracted, as described in this application, and then matched with stored WIER 140 or WIER templates 235 using a probe/gallery matching component 205, which can be implemented using a nearest neighbor or approximate nearest neighbor approach, their variants, or alternatives.

A match is said to have occurred if the distance between the probe WIER 290 and a gallery item falls below a predetermined threshold. Distances, in this context, can be defined using standard measures of distance between vectors, including L2, cosine, their variants, or alternatives, and the similarity threshold can be determined empirically. Once a match is established, the stored identification of the enrolled person is assigned to the input image, indicating that they are presumed to be present in the input.

In the traditional face recognition systems, the time to identify an individual in the visual representation 200 increases with the number of people in the query image. In the system 100, the time to identify the individual in the visual representation 200 is independent of the number of people in the visual representation.

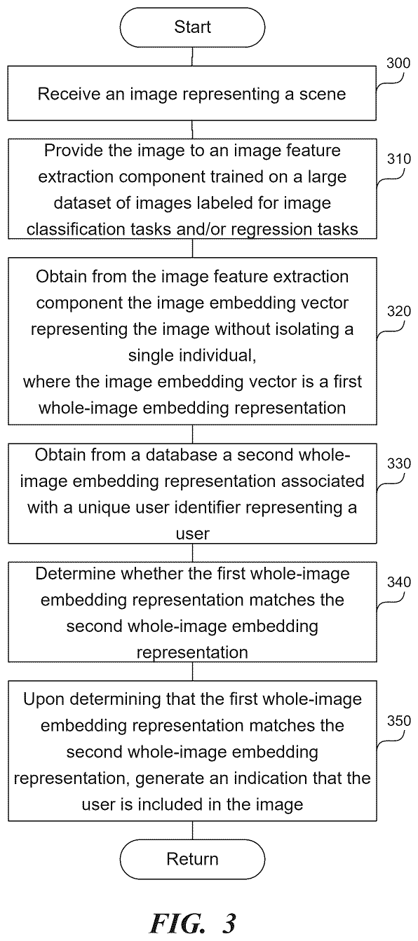

FIG. 3 is a flowchart of a method to identify a person in a visual representation containing multiple people while preserving privacy. A hardware or software processor executing instructions describing this application can in step 300 receive a visual representation, e.g., a whole image representation, of a scene. The scene can include multiple people, objects, plants, animals, and/or backgrounds, etc. The visual representation can be an image, a video, a three-dimensional representation, a hologram, etc.

In step 310, the processor, without isolating (e.g., localizing) an individual among the multiple people in the visual representation, can provide the visual representation to an image feature extraction component trained on a large dataset of visual representations labeled for visual representation classification tasks and/or regression tasks. By not isolating an individual, the individual's privacy is preserved, and the system can comply with various privacy statutes in various jurisdictions.

In step 320, the processor can obtain from the image feature extraction component the image embedding vector representing the multiple people in the visual representation without isolating a single individual, where the image embedding vector is a first numerical vector in a first multidimensional space, and where the image embedding vector is a first whole-image embedding representation.

In step 330, the processor can obtain from a database a second whole-image embedding representation associated with a unique user identifier representing a user, where the second whole-image embedding representation is a fourth numerical vector in the third multidimensional space.

In step 340, the processor can determine whether the first whole-image embedding representation matches the second whole-image embedding representation.

To determine whether the two whole-image embedding representations match, the processor can determine the similarity between two multidimensional vectors, which involves calculating a similarity measure. There are several methods to achieve this, each suited to different contexts and data types. Once the similarities are determined, the processor can compare the similarity to a predetermined threshold appropriate to the particular similarity measure, and depending on the comparison, the processor can determine that the two vectors match or do not match.

One common similarity measure is the Euclidean distance, which measures the straight-line distance between two points in a multidimensional space. It is calculated by taking the square root of the sum of the squared differences between corresponding elements of the vectors. For example, if vectors A and B are (1, 2, 3) and (4, 5, 6) respectively, the Euclidean distance is approximately 5.20. The predetermined threshold for the Euclidean distance can be a 30% of the greater vector magnitude.

Another similarity measure is cosine similarity, which measures the cosine of the angle between two vectors, indicating how similar the vectors are in terms of direction. This is calculated by dividing the dot product of the vectors by the product of their magnitudes. Using the same vectors A and B, the cosine similarity is approximately 0.97, suggesting a high degree of similarity in direction. The predetermined threshold for the cosine distance can be 0.7.

Manhattan distance, also known as L1 distance or taxicab distance, is another similarity measure that sums the absolute differences of the coordinates. For vectors A and B, the Manhattan distance is 9. This measure is particularly useful in high-dimensional spaces where differences are sparse. The predetermined threshold for the Manhattan distance can be a percentage of the magnitude of the greater vector such as 70%.

The Pearson correlation coefficient measures the linear correlation between two vectors. It is calculated by dividing the covariance of the vectors by the product of their standard deviations. This coefficient is useful for understanding the linear relationship between vectors. The predetermined threshold for the Pearson correlation can be .3.

Choosing the right measure depends on the specific requirements of the task. Euclidean distance is useful when the magnitude of differences is important, while cosine similarity is ideal when the direction of the vectors is more significant than their magnitude. Manhattan distance is suitable for high-dimensional spaces with sparse differences, and Pearson correlation is best for measuring linear relationships. By selecting the appropriate similarity measure, one can effectively determine the similarity between multidimensional vectors, aiding in tasks such as pattern recognition, clustering, and classification.

In step 350, upon determining that the first whole-image embedding representation matches the second whole-image embedding representation, the processor can generate an indication that the user is included in the visual representation.

The processor can provide the image embedding vector to a text generation component trained on visual representations and corresponding first multiplicity of textual descriptions. The processor can obtain from the text generation component a text that describes the content associated with the visual representation. The processor can provide the text that describes the content associated with the visual representation to a semantic generator trained on a second multiplicity of textual descriptions. The processor can obtain from the semantic generator a semantic representation, where the semantic representation is a second numerical vector in a second multidimensional space. The processor can combine the image embedding vector and the semantic representation to obtain the first whole-image embedding representation, where the first whole-image embedding representation is a third numerical vector in a third multidimensional space. The third multidimensional space can be an addition of the first and second multidimensional spaces.

The processor can obtain from the text generation model an intermediate representation, where the intermediate representation is a fifth numerical vector in a fourth multidimensional space. The processor can combine the image embedding vector, the semantic representation and the intermediate representation to obtain the first whole-image embedding representation by, for example, concatenating the image embedding vector, the semantic representation and the intermediate representation. Alternatively, the processor can combine the image embedding vector, the semantic representation and the intermediate representation to obtain the first whole-image embedding representation by training a machine learning network to combine the image embedding vector, the semantic representation and the intermediate representation into the first whole-image embedding representation.

The intermediate representation in the context of an RNN typically refers to the state or output of the network at a given time step that encapsulates some kind of compressed or abstracted version of the input sequence processed so far. These intermediate representations are crucial for the RNN to maintain memory of previous inputs, which is why they are often referred to as the hidden states or latent representations.

At each time step, an RNN updates its hidden state based on the current input and the previous hidden state. This hidden state is the intermediate representation that encodes information about the sequence seen so far. The hidden state is updated using the activation function (like tanh or rectified linear unit) of the previous hidden state and the current input. The recurrent nature of this update allows the network to “remember” past information and maintain a form of memory.

The intermediate representation captures the context of the sequence at each time step. This allows the RNN to process time-series data or sequential inputs like text or speech and remember relevant information about previous steps. The recurrent connections give the network the ability to maintain a kind of “memory” over long sequences, even though each individual time step might only capture a small, localized feature.

In more advanced RNNs like LSTMs (Long Short-Term Memory) or GRUs (Gated Recurrent Units), the intermediate representation is more structured.

LSTMs, for instance, maintain two types of intermediate representations: the hidden state hth_tht and the cell state ctc_tct. While the hidden state represents the output of the network at each time step, the cell state holds long-term memory, and both are updated with different gating mechanisms to control what information is passed forward.

These intermediate representations (the hidden states) are often used to make predictions or decisions, either by directly feeding them into an output layer (e.g., for classification or regression tasks) or by aggregating them across time (e.g., in sequence-to-sequence tasks).

For a sentence like “The cat sat on the mat,” the intermediate representations (hidden states) of an RNN would capture information about the words processed so far. At time step 1: The RNN processes “The,” and its hidden state encodes the meaning/context of the word “The.” At time step 2: It processes “cat,” and the hidden state now reflects both “The” and “cat” together. As the sequence continues, the hidden states evolve to capture increasingly complex relationships within the sentence.

The processor can combine the image embedding vector and the semantic representation into the first whole-image embedding representation by concatenating the image embedding vector, the semantic representation and the intermediate representation. Alternatively, the processor can combine the image embedding vector and the semantic representation into the first whole-image embedding representation by training a machine learning network to combine the image embedding vector and the semantic representation into the first whole-image embedding representation.

To obtain from the database the second whole-image embedding representation associated with a unique user identifier, the processor can obtain multiple second whole-image embedding representations corresponding to multiple visual representations, where a single second whole-image embedding representation among the multiple second whole-image embedding representations corresponds to a single visual representation among the multiple visual representations. The processor can create the second whole-image embedding representation by averaging the multiple second whole-image embedding representations.

Identity Classification in Visual Digital Content Based on Whole-Image Representations with Partial Individual Approval

The disclosed system is intended for use-cases where we can guarantee that one of the two sides in 1:1 verification did provide authorization to be recognized but cannot guarantee that the other side provided authorization. For instance, a system to which people enroll for it to search for their likeness in online photos. In such use cases, we want the increased recognition accuracy of using a face-specific representation generated from a face-specific model.

In such use cases, the system described by the disclosed system produces a WIER for images on the side where authorization is unavailable. For the side where we have authorization for the system to recognize, the disclosed system produces a face-specific representation using a face model such as those used by existing face recognition systems. Those two representations, however, are not comparable: it is an “apples to oranges” comparison. And so, the system cannot directly use these two representations in a 1:1 verification system.

To compare the WIER produced for one side of a 1:1 verification with a face-specific representation, the disclosed system further proposes to create a “mapping” (referred to also as a “conversion”) from face-specific representation to WIER. This mapping is performed by a machine learning method trained for this task. This mapping converts a standard face-specific representation to a WIER, allowing the system to compare the two sides, both now represented using WIER. The disclosed system, therefore, does not extract face-specific information, using face models, from images showing people who may not have given authorization to be recognized.

The disclosed system is not designed to match the accuracy or efficiency of existing face recognition systems. Instead, it is designed to avoid extracting and potentially collecting face-specific information from the images of people who may not have consented to being recognized by the system.

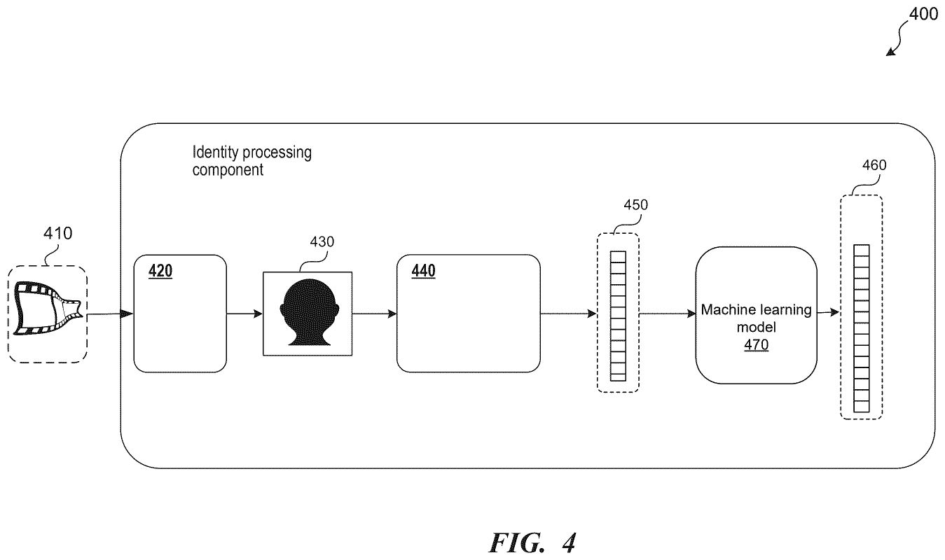

FIG. 4 shows an identity recognition system 400, such as a face recognition system, when an individual allows to be recognized. The system 400 can determine whether the individual has allowed to be recognized, and if so, the system can receive as input the input visual representation 410 including a single individual and can be cropped to focus on the single individual. The visual representation 410 can be an image, a video, a three-dimensional representation a hologram, etc.

The preprocessing component 420 can apply various image enhancing methods to the image, such as geometric transformations for alignment, including 2D or 3D face alignment, image scaling, or cropping, photometric transformations for color correction and enhancement, or any other steps needed to improve the performance of downstream processing. The resulting intermediate image 430 can be then processed by identity embedding (face embedding) extraction component 440, which can apply a machine learning module trained on large collections of faces and their associated identities to extract an embedding vector 450 referred to as an identity embedding or a face embedding in the context of a face recognition systems.

Component 440 is designed to produce identity embeddings 450 that are, ideally, both invariant—that is, contain similar values when extracted from different images of the same person—and discriminative—that is, contain different values when extracted from images of different people. Identity embedding 450 may or may not be opaque. If the identity embedding 450 is opaque, its values do not represent human-readable quantities. If the identity embedding 450 is not opaque, the values are human-readable.

The identity embedding 450 can be an embedding vector, e.g., numerical vector, in a multidimensional space. The identity embedding 450 can uniquely identify the person. The system 400 can store the identity embedding 450 in the database 150 in FIGS. 1-2. The identity embedding 450 is not the whole-image embedding representation because the identity embedding 450 does not hide the individual identity. In addition, the multiple dimensional spaces of the identity embedding 450 is different from the multidimensional space of the whole-image embedding representation 290 in FIG. 2, thus making the comparison between the identity embedding 450 and the whole-image embedding representation 290 meaningless.

To hide the individual identity and obtain the whole-image embedding representation 460, which can be compared to other whole-image embedding representations described in this application, the system 400 can provide the identity embedding 450 to a machine learning model 470 trained to convert the identity embedding 450 into the whole-image embedding representation 460. The system can store the whole-image embedding representation 460 in the database 150. The database 150 can include only identity embeddings, only whole-image embedding representations, or a mix of the two, depending on whether the user allowed to be identified or not.

The whole-image embedding representation 460 is a numerical vector in the same multidimensional space as the whole-image embedding representation 290 in FIG. 2. Consequently, the system as described in this application can compare the whole-image embedding representation 460 from an individual who has allowed to be recognized with the whole-image embedding representation 290 in FIG. 2 containing one or more individuals who have not allowed to be recognized.

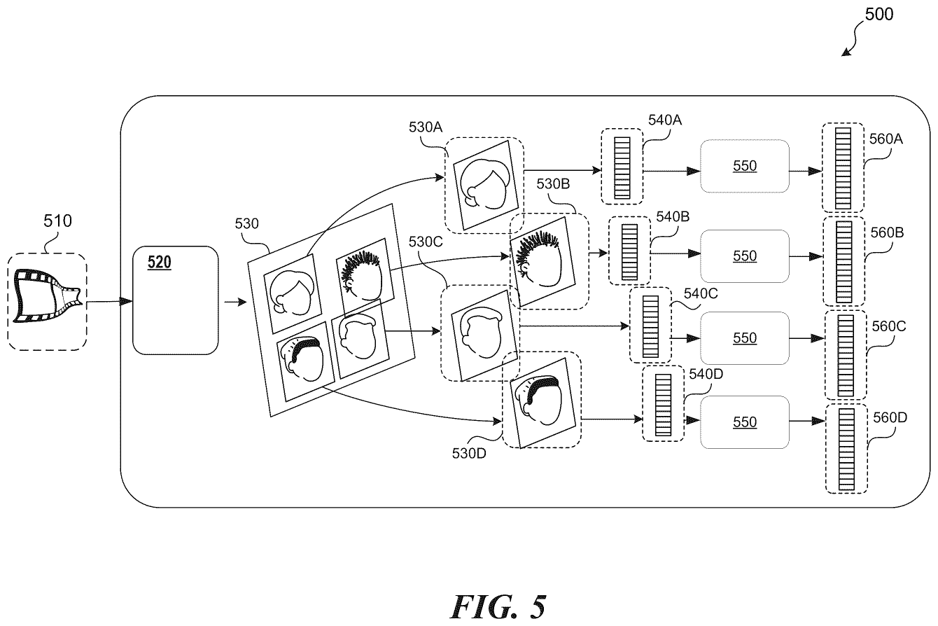

FIG. 5 shows an identity recognition system 500, such as a face recognition system, that can isolate individuals from an image containing multiple people. The system 500 can determine whether the individuals in the visual representation 510 have allowed to be recognized and if so, the system can receive as input the visual representation 510, e.g. an image.

A spatial localization component 520, such as a face tractor, can process the image 510. Spatial localization component 520 outputs the image coordinates 530 where each person appears in the image 510. If no person appears in the image, no image coordinates are output. These coordinates 530 often take the form of a bounding box surrounding the appearance of each person in the image 510, 6DoF face pose, their variants, or alternatives for spatial localization.

In FIG. 5, a bounding box 530A, 530B, 530C, 530D can be associated with each of the four faces appearing in the image 510. Each person is then processed separately, typically by cropping the input image to coordinates obtained from the bounding boxes 530A, 530B, 530C, 530D provided by spatial localization component 520. The bounding boxes 530A, 530B, 530C, 530D corresponding to each person in the input image 510 can be then processed separately to obtain identity embedding 540A, 540B, 540C, 540D.

The identity embedding 540 is an identity embedding or a face embedding that exists in the same multidimensional space as the identity embedding 450 in FIG. 4. The identity embedding 540 can be both invariant—that is, contain similar values when extracted from different images of the same person—and discriminative—that is, contain different values when extracted from images of different people. The identity embedding 540A, 540B, 540C, 540D can uniquely identify an individual, and the system 500 can only create the identity embeddings if the individuals have agreed to be identified.

The identity embeddings 540A, 540B, 540C, 540D can be numerical vectors in the same multidimensional space as the identity embedding 450 in FIG. 4. Consequently, identity embeddings 540A, 540B, 540C, 540D cannot be compared to a whole-image embedding representation, such as whole-image embedding representation 290 in FIG. 2, because the multidimensional space of the identity embeddings 540A, 540B, 540C, 540D is different from the multidimensional space of the image embedding representation 290.

The database 150 in FIG. 1 can store whole-image embedding representations 140 in FIG. 1. To be able to determine whether any individuals represented by whole-image embedding representations 140 are contained in the visual representation 510, a machine learning model 550 can be trained to convert an identity embedding into the whole-image embedding representation. Consequently, the system 500 can provide the identity embeddings 540A, 540B, 540C, 540D to the machine learning model 550 and obtain whole-image embedding representations 560A, 560B, 560C, 560D corresponding to each of the individuals in the image.

Consequently, instead of whole-image embedding representation 290 in FIG. 2, the system 500 can supply the whole-image embedding representations 560A, 560B, 560C, 560D for comparison with the whole-image embedding representations 140 stored in the database 150.

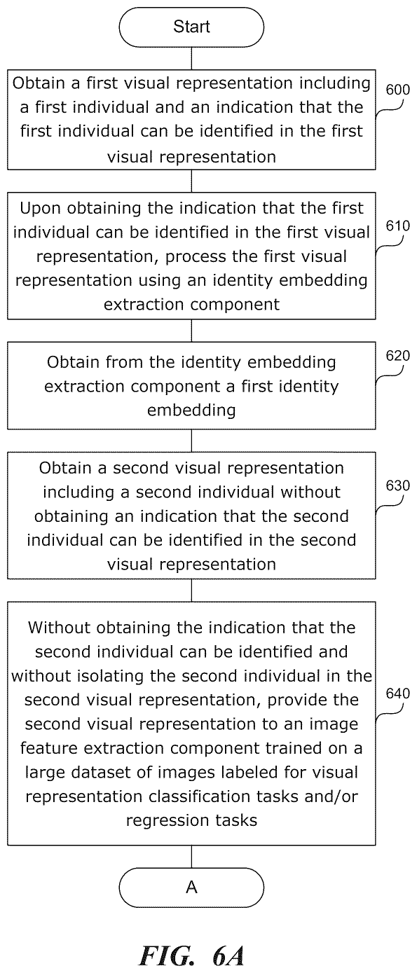

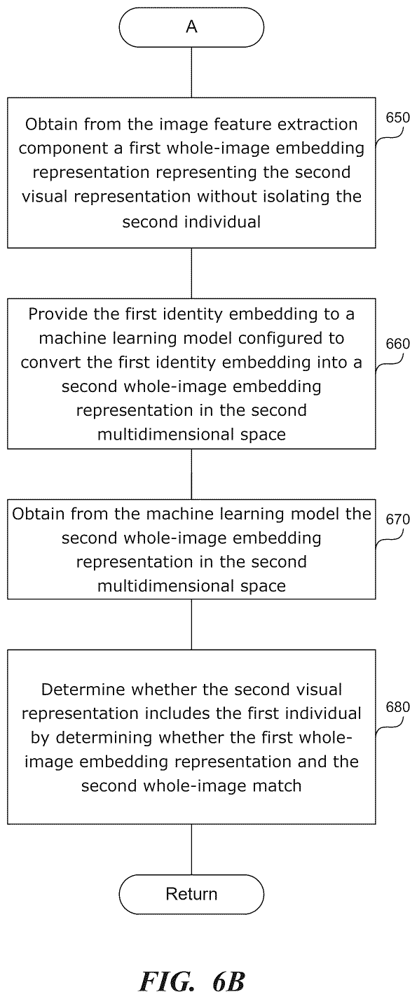

FIGS. 6A-6B show a flowchart of a method to perform identity classification when not all participants have agreed to be identified. A hardware or software processor executing instructions describing this application can in step 600 obtain a first visual representation including a first individual and an indication that the individuals, such as the first individual, can be identified in the first visual representation. In other words, the first individual and other individuals in the image can all allow to be identified. For example, the individual can select a graphical user interface button that allows the processor to identify the individual in the visual representation. The visual representation, as described in this application, can be an image, a video, a three-dimensional representation, etc., of a person.

In step 610, upon obtaining the indication that the first individual can be identified in the first visual representation, the processor can process the first visual representation using an identity embedding extraction component, which applies a machine learning module. The identity embedding extraction component can be trained on collections of faces.

In step 620, the processor can obtain from the identity embedding extraction component a first identity embedding, where the first identity embedding is a first numerical vector in a first multidimensional space. The first identity embedding can include similar values to a second identity embedding extracted from a different image of the first individual. The first identity embedding can include different values from a third identity embedding extracted from a second image of a second individual, where the first individual and the second individual are different.

In step 630, the processor can obtain a second visual representation including a second individual without obtaining an indication that the second individual can be identified in the second visual representation, where the second visual representation includes an animate object or an inanimate object in addition to the second individual. For example, the second individual can explicitly choose to not be identified, and the processor can receive an explicit indication that the second individual cannot be identified, e.g. isolated in the image. Alternatively, the processor may not have received the explicit approval to be identified from the second individual, and consequently, the processor proceeds without isolating the second individual. In step 640, without obtaining the indication that the second individual can be identified in the second visual representation, without isolating the second individual in the second visual representation, the processor can provide the second visual representation to an image feature extraction component trained on a large dataset of images labeled for visual representation classification tasks and/or regression tasks.

In step 650, the processor can obtain from the image feature extraction component a first whole-image embedding representation representing the second visual representation without isolating the second individual, where the first whole-image embedding representation is a second numerical vector in a second multidimensional space.

In step 660, the processor can provide the first identity embedding to a machine learning model configured to convert the first identity embedding into a second whole-image embedding representation in the second multidimensional space.

In step 670, the processor can obtain from the machine learning model the second whole-image embedding representation in the second multidimensional space.

In step 680, the processor can determine whether the second visual representation includes the first individual by determining whether the first whole-image embedding representation and the second whole-image match. The similarity can be calculated as described in this application using various similarity measures such as cosine similarity, Euclidean distance, Manhattan distance and/or Pearson correlation.

In one embodiment, the processor can perform additional steps to create the first whole-image embedding representation. The processor can obtain from the image feature extraction component an image embedding vector representing the second individual and the animate object or the inanimate object. The processor can provide the image embedding vector to a text generation component trained on visual representations and corresponding first multiplicity of textual descriptions. The processor can obtain from the text generation component a text that describes the content associated with the second visual representation. The processor can provide the text that describes the content associated with the second visual representation to a semantic generator trained on a second multiplicity of textual descriptions. The processor can obtain from the semantic generator a semantic representation, where the semantic representation is a third numerical vector in a third multidimensional space. Finally, the processor can combine the image embedding vector and the semantic representation to obtain the first whole-image embedding representation.

In another embodiment, the processor can perform different additional steps to create the first whole-image embedding representation. The processor can provide the image embedding vector to a text generation component trained on visual representations and corresponding first multiplicity of textual descriptions. The processor can obtain from the text generation model an intermediate representation, where the intermediate representation is a fourth numerical vector in a fourth multidimensional space. The processor can obtain from the text generation component a text that describes the content associated with the second visual representation. The processor can provide the text that describes the content associated with the second visual representation to a semantic generator trained on a second multiplicity of textual descriptions. The processor can obtain from the semantic generator a semantic representation, where the semantic representation is a third numerical vector in a third multidimensional space. The processor can combine the image embedding vector, the semantic representation and the intermediate representation to obtain the first whole-image embedding representation by concatenating the image embedding vector, the semantic representation and the intermediate representation.

In a third embodiment, the processor can perform different additional steps to create the first whole-image embedding representation. The processor can provide the image embedding vector to a text generation component trained on visual representations and corresponding first multiplicity of textual descriptions. The processor can obtain from the text generation model an intermediate representation, where the intermediate representation is a fourth numerical vector in a fourth multidimensional space. The processor can obtain from the text generation component a text that describes the content associated with the second visual representation. The processor can provide the text that describes the content associated with the second visual representation to a semantic generator trained on a second multiplicity of textual descriptions. The processor can obtain from the semantic generator a semantic representation, where the semantic representation is a third numerical vector in a third multidimensional space. Finally, the processor can combine the image embedding vector, the semantic representation and the intermediate representation to obtain the first whole-image embedding representation by training a machine learning network to combine the image embedding vector, the semantic representation and the intermediate representation into the first whole-image embedding representation. Alternatively, the processor can combine the image embedding vector and the semantic representation into the first whole-image embedding representation by concatenating the image embedding vector, the semantic representation and the intermediate representation.

To obtain from the database the second whole-image embedding representation associated with a unique user identifier representing the user, the processor can obtain a whole-image embedding representation template. Specifically, the processor can obtain multiple second whole-image embedding representations corresponding to multiple visual representations, where a single second whole-image embedding representation among the multiple second whole-image embedding representations corresponds to the first individual. The processor can create the second whole-image embedding representation by averaging the multiple second whole-image embedding representations.

The processor, prior to obtaining the first visual representation, can enhance the first visual representation by preprocessing. Specifically, the processor can obtain a third visual representation including the first individual and a fourth individual. The processor can enhance the third visual representation by performing face alignment, visual representation scaling, or color correction. Upon obtaining the indication that the first individual can be identified in the first visual representation, isolate the first individual in the second visual representation to obtain the first visual representation.

### Identifying Unauthorized Use of Visual Digital Content Via Whole-Image Embedding Representations

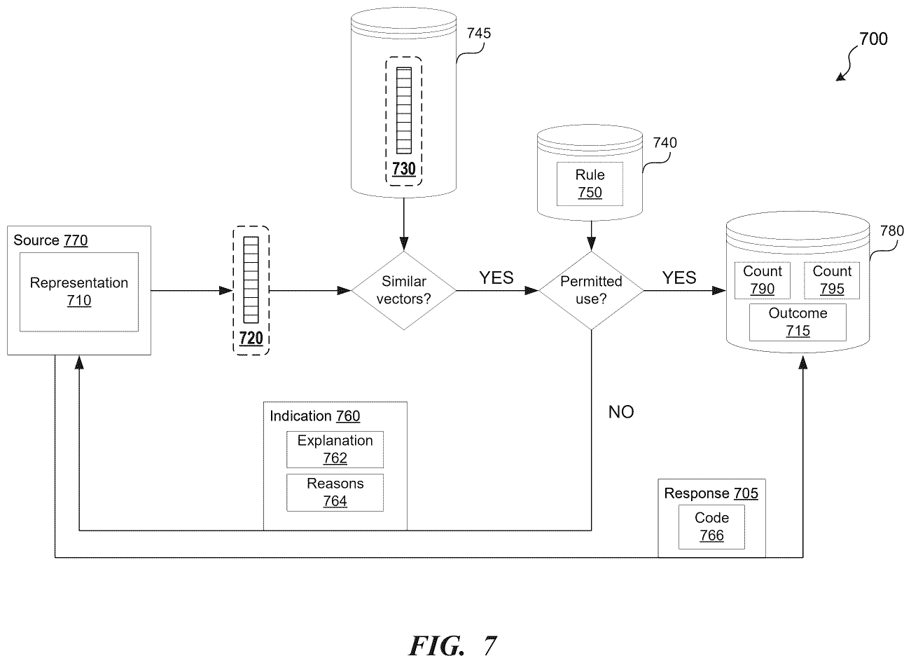

FIG. 7 shows a system to identify unauthorized use of visual digital content via whole-image embedding representations. The system 700 can receive a representation 710 including a content that includes one or more people. The representation 710 can be visual, such as image, video, three-dimensional representation, illustration (e.g., a cartoon), or silhouette of an individual. The representation 710 can include a walking sequence of the individual, or the representation 710 can include an audio of the individual.

Without obtaining an indication that every individual associated with the representation 710 can be identified—that is, without knowing that every individual provided consent to be identified—the system 700 can determine whether a user of the system is included in the representation. Without isolating an individual in the representation 710, the system 700 can obtain a first whole-image embedding representation (WIER) 720 representing the one or more people in the visual representation without isolating a single individual, as described in this application.

The system 700 can obtain from a first datastore 745 a second whole-image embedding representation 730 representing a user of the system and can determine whether the user is included in the representation 710 by comparing the first WIER 720 and the second whole-image embedding representation 730. The comparison can be done using similarity measures as described in this application.

Upon determining that the user is included in the representation 710, the system 700 can retrieve from a second datastore 740 a rule 750 associated with the second whole-image embedding representation 730. The rule 750 can indicate permitted uses of the representation 710. For example, the rule 750 can indicate that any use of the representation 710 is not permitted. Alternatively, the rule 750 can indicate that certain sources can use the representation 710 and the ways in which the certain sources can use the data, but certain other sources cannot. In a third example, the rule 750 can indicate that the representation 710 cannot be associated with certain items such as cigarettes, vaping, or alcohol. The use can include posting and/or providing the representation via the Internet such as a website and/or distributing the representation by electronic means.

The system 700 can determine whether the rule 750 associated with the second whole-image embedding representation 730 permits use of the representation 710. Upon determining that the rule 750 associated with the second whole-image embedding representation 730 does not permit use of the representation 710, the system 700 can send an indication 760 that the rule associated with the second whole-image embedding representation does not permit use of the representation to a source 770 associated with the representation. The indication 760 can include a requested action such as blocking or removing representation 710, making a payment associated with the representation 710, etc. The source 770 can include a unique identifier such as an Internet protocol (IP) address, an email address, phone number, physical address, name, etc.

The indication 760 can include an explanation 762 of the rule 750 as well as enumerations of the multiple reasons 764 why the source 770 can provide the representation 710. The enumerations can include codes representing the multiple reasons 764. The multiple reasons 764 can include fair use or a permission granted to the source 770 to use the representation 710. For example, the codes indicating fair use can be FU01, while the code for permission granted can be PG01. The source 770 can provide a response 705 that includes a code 766 representing the reason justifying the use of the representation 710 as well as any documentation supporting the code 766.

In addition, the system 700 keeps a count 790 in the datastore 780 of the number of times that the representation 710 complied with the rule 750 and a count 795 of the number of times that the representation 710 did not comply with the rule 750. The datastores 740, 745, 780 can be the same datastore or different datastores. Further, the system 700 can store the received responses 705 and the final outcome 715 associated with the representation 710.

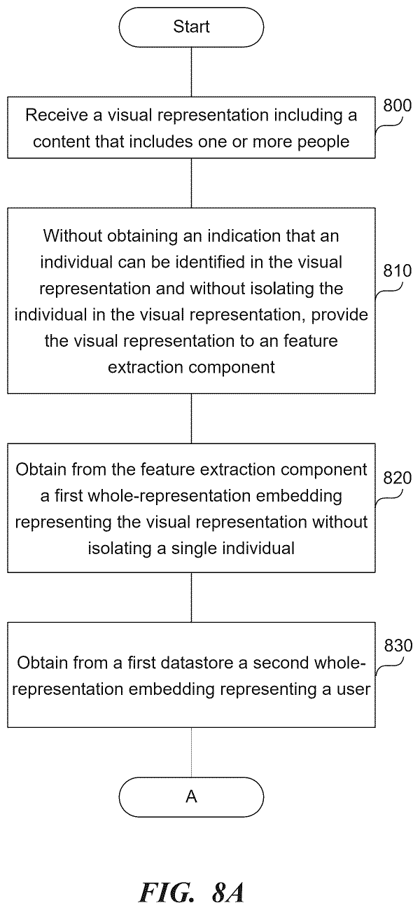

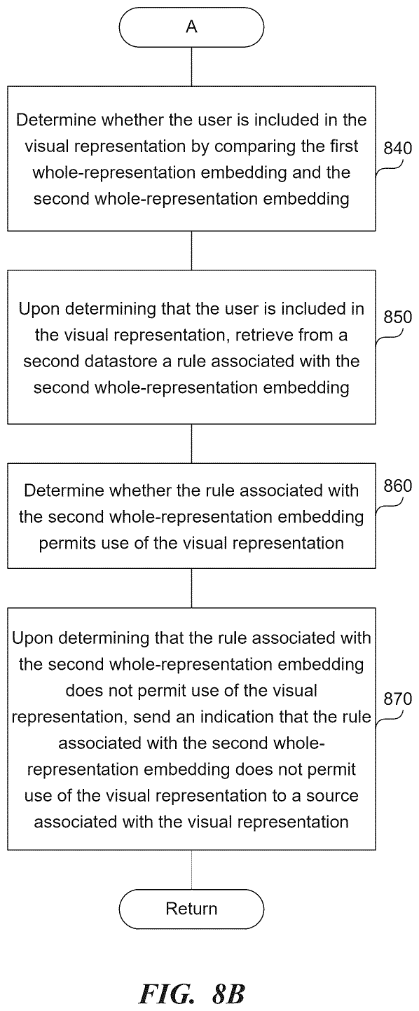

FIG. 8A-8B are a flowchart of a method to identify unauthorized use of digital content. A hardware or software processor executing instructions described in this application can in step 800 receive a representation including a scene and an indication of use associated with the representation. The scene can include one or more people. The representation includes an indication of an individual associated with the scene. The representation can uniquely identify an individual and can be visual, auditory, a walk cycle, etc., as described in this application. The indication of use can include the source using the representation and how the representation is used. For example, the source can be identified using a unique identifier including a web address, a phone number, an email, and/or a name, and the use can include providing the representation, distributing the representation, etc.

In step 810, the processor, without obtaining an indication that an individual can be identified and without isolating the individual associated with the scene, can provide the representation to a feature extraction component trained on a large dataset of representations labeled for representation classification tasks and/or regression tasks. The feature extraction component can be an image feature extraction component. The extracted features can include body structure, limb movement, walking speed, shape, contour, motion, facial features, body proportions, hairstyle, clothing, pitch, tone, cadence, and/or accent.

In step 820, the processor can obtain from the feature extraction component a first whole-representation embedding representing the scene without isolating a single individual, where the first whole-representation embedding is a first numerical vector in a first multidimensional space. The whole-representation embedding can be the whole-image embedding representation (WIER).

In step 830, the processor can obtain from a first datastore a second whole-representation embedding representing a user, where the second whole-representation embedding is a second numerical vector in the first multidimensional space.

In step 840, the processor can determine whether the user is included in the representation by comparing the first numerical vector and the second numerical vector. In step 850, upon determining that the user is included in the representation, the processor can retrieve from a second datastore a rule associated with the second whole-representation embedding.

In step 860, the processor can determine whether the rule associated with the second whole-representation embedding permits use of the representation. In step 870, upon determining that the rule associated with the second whole-representation embedding does not permit use of the representation, the processor can send an indication that the rule associated with the second whole-representation embedding does not permit use of the representation to a source associated with the representation. The indication can include a desired action such as removing the representation.

Upon determining that the user is included in the representation, the processor can retrieve from the second datastore the rule associated with the second whole-representation embedding, where the rule indicates a first source that can use the representation associated with the user. The processor can determine whether the representation conflicts with the rule associated with the second whole-representation embedding by determining whether the source associated with the representation matches the first source. Upon determining that the source associated with the representation does not match the first source, the processor can send an indication of the conflict to the source associated with the representation.

The processor can obtain from the second datastore multiple codes associated with multiple responses. Upon determining that the rule associated with the second whole-representation embedding does not permit use of the representation, the processor can send the indication that the rule associated with the second whole-representation embedding does not permit use of the representation to the source associated with the representation. The indication can include one or more of the multiple codes and an invitation to respond using the one or more of the multiple codes.

Upon determining that the rule associated with the second whole-representation embedding permits use of the representation, the processor can increase a first indicator in the second datastore, where the first indicator indicates a number of times the rule associated with the second whole-representation embedding is found to permit use. Upon determining that the rule associated with the second whole-representation embedding does not permit use of the representation, the processor can increase a second indicator in the second datastore, where the second indicator indicates a number of times the rule associated with the second whole-representation embedding is found not to permit use.

Upon determining that the rule associated with the second whole-representation embedding permits use of the representation, the processor can increase a first indicator in the second datastore, where the first indicator indicates a number of times the rule associated with the second whole-representation embedding is found to permit use. Upon determining that the rule associated with the second whole-representation embedding does not permit use of the representation, the processor can increase a second indicator in the second datastore, where the second indicator indicates a number of times the rule associated with the second whole-representation embedding is found not to permit use. The processor can obtain from the second datastore multiple codes associated with multiple responses. Upon determining that the rule associated with the second whole-representation embedding does not permit use of the representation, the processor can send the indication that the rule associated with the second whole-representation embedding does not permit use of the representation to the source associated with the representation, where the indication includes one or more of the multiple codes and an invitation to respond using the one or more of the multiple codes. The processor can receive a response from the source associated with the representation, where the response includes the one or more of the multiple codes. The processor can store the received one or more of the multiple codes in the second datastore.

The processor can obtain a second representation associated with the user and an indication that the user can be identified in the second representation. Upon obtaining the indication that the user can be identified in the second representation, the processor can process the second representation using an identity embedding extraction component. The identity embedding extraction component can be trained on collections of visual representations, audio representations, or walking sequences. The processor can obtain from the identity embedding extraction component a first identity embedding, where the first identity embedding is a third numerical vector in a second multidimensional space. The processor can provide the first identity embedding to a machine learning model configured to convert the first identity embedding into the second whole-representation embedding in the first multidimensional space. The processor can obtain from the machine learning model the second whole-representation embedding in the second multidimensional space.

The processor can receive the representation including the scene, where the representation includes an at least one of an image, an audio, a video, a walking sequence, a point cloud or a three-dimensional representation. Without isolating the individual associated with the scene, the processor can provide the representation to a feature extraction component trained on a large dataset of representations labeled for representation classification tasks and/or regression tasks, where the feature extraction component is configured to extract a distinctive attribute associated with the user including a body structure, a limb movement, a walking speed, a shape, a contour, a motion, a facial feature, a body proportion, a hairstyle, a clothing, a pitch, a tone, a cadence, or an accent.

### Identifying Unauthorized Use of Digital Content

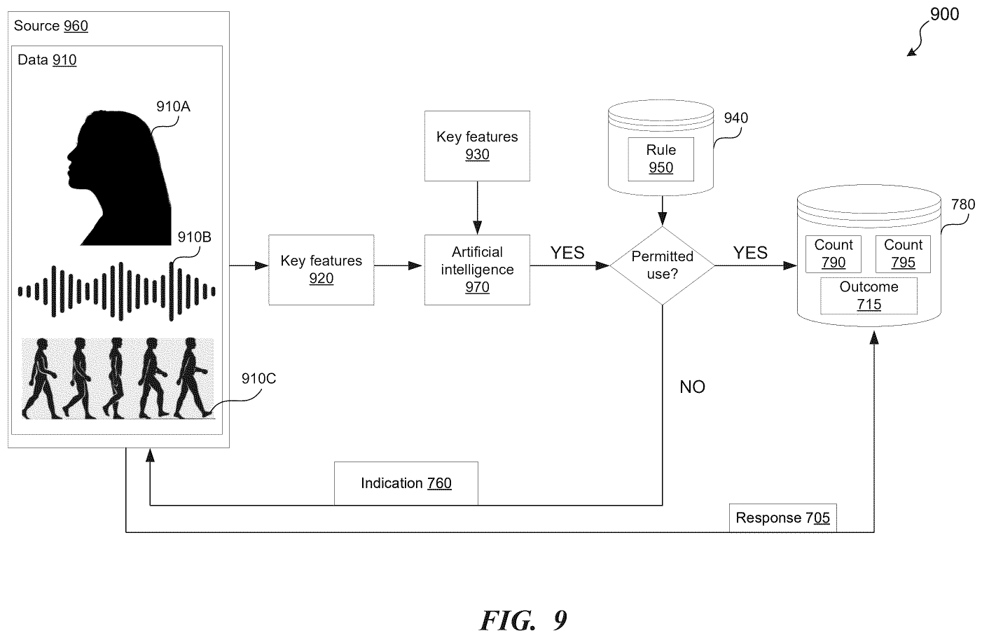

FIG. 9 shows a system to identify unauthorized use of digital content. The system 900 can receive data 910 indicating an individual. The data 910 can include one or more of a visual representation 910A, an audio representation 910B, or a walking sequence 910C. In addition, the data 910 can include multiple representations of the individual within the same category. For example, if the data 910 is the visual representation 910A, the data 910 can include an image of the person as a baby, an image of the person after a gender transition, and/or an image of the person as a senior. In another example, the visual representation 910A can include various visuals such as an image, a video, a three-dimensional representation, a silhouette, an illustration including a cartoon representation, or a sketch, etc.

The system 900 can perform preprocessing associated with the data to isolate the individual and to enhance data quality. The preprocessing can vary based on the type of the data 910, visual, audio, or walking sequence, as described in this application.

The system 900 can extract a first multiplicity of key features 920 associated with the data 910, where the first multiplicity of key features tend to uniquely identify the individual. The first multiplicity of key features 920 can include one or more of: a body structure, a limb movement, a walking speed, a shape, a contour, a motion, a facial feature, a body proportion, a hairstyle, a clothing, a pitch, a tone, a cadence, or an accent.

The system 900 can compare, using artificial intelligence 970, the first multiplicity of key features 920 associated with the data 910 to a second multiplicity of key features 930 associated with a user to determine whether the data indicates the user. The first and second multiplicity of key features 920, 930 can be encoded in various ways, including whole-image embedding representations, as described in this application.

Upon determining that the data indicates the user, the system 900 can retrieve from a datastore 940 a rule 950 associated with the second multiplicity of key features 930. The rule 950 can indicate permitted uses of the data 910. For example, the rule 950 can indicate that any use of the data 910 is not permitted. Alternatively, the rule 950 can indicate that certain sources can use the data 910 and the ways in which the certain sources can use the data, but certain other sources cannot. In a third example, the rule 950 can indicate that the data 910 cannot be associated with certain items such as cigarettes, vaping, or alcohol.

The system 900 can determine whether the rule 950 associated with the second multiplicity of key features 930 permits use of the data 910 indicating the individual. Upon determining that the rule associated with the second multiplicity of key features 930 does not permit use of the visual representation, the system 900 can send an indication 760 that the rule 950 associated with the second multiplicity of key features does not permit the use of the data 910 indicating the individual to a source 960 associated with the data indicating the individual. The system 900 can receive the response 705 in FIG. 7 and can also store count 790, 795 in FIG. 7 as well as the outcome 715 in the datastore 780.

If the data 910 includes a walking sequence 910C, the system can perform gait recognition to identify the first multiplicity of key features 920. Gait recognition is a sophisticated biometric technique that identifies individuals based on their unique walking sequences. This method leverages the distinct characteristics of a person's gait, which are influenced by factors such as body structure, limb movement, and walking speed. The process begins with data acquisition, where walking sequences are captured using video cameras, depth sensors, or wearable devices. The acquired data undergoes preprocessing to enhance quality and isolate the walking subject. Key features are then extracted, either through model-based approaches that analyze joint angles and limb movements or appearance-based methods that focus on the silhouette's shape and motion. These features are represented in forms like Gait Energy Images (GEI) or Gait Entropy Images (GEnI), which encapsulate the walking sequence over a gait cycle. Finally, classification algorithms, including machine learning techniques like Support Vector Machines (SVM) and deep learning models such as Convolutional Neural Networks (CNN), are employed to compare the extracted features with a datastore of known patterns, thereby identifying the individual.

The data 910 can include a visual representation 910A such as an image, video, or a three-dimensional model. In that case, the process begins with the acquisition of the visual data, which can be a static image, a sequence of frames in a video, or a 3D model captured through various scanning technologies. For images and videos, the initial step involves pre-processing to enhance quality and reduce noise, followed by the detection and extraction of key facial features using algorithms such as Haar cascades or deep learning models like CNNs. These features typically include the eyes, nose, mouth, and the overall facial contour. In the case of 3D models, the process involves capturing the geometric structure of the face, which provides depth information that can be crucial for accurate recognition.

Once the features are extracted, they are mapped into a feature space using techniques like FaceNet, which transforms the facial features into a multidimensional vector space where similar faces are positioned closer together. For images and videos, the system compares these vectors against a database of known faces using similarity measures such as Euclidean distance. In video recognition, additional steps include tracking the face across frames to maintain consistency and improve accuracy. For 3D models, the recognition process benefits from the additional depth information, allowing for more robust matching even under varying lighting conditions and angles.

The entire recognition process is supported by extensive datasets and continuous learning mechanisms to handle variations in facial expressions, aging, gender transitions, and other dynamic factors. This comprehensive approach ensures that the system can accurately identify individuals across different types of visual data, making it a powerful tool for applications in security, authentication, and social media.

If the data 910 includes a visual representation 910A such as a silhouette, the system can perform silhouette recognition to identify the first multiplicity of key features 920. Silhouette recognition is a biometric technique that identifies individuals based on the analysis of their body outlines or contours. This method relies on the unique shape and movement patterns of a person's silhouette, which can be captured through video cameras or depth sensors. The process begins with data acquisition, where images or video sequences of individuals are recorded. These images undergo preprocessing steps such as background subtraction to isolate the silhouette from the background and noise reduction to enhance the quality of the data. Once the silhouette is isolated, key features are extracted, focusing on the shape, contour, and motion of the silhouette. These features can be represented in various forms, such as binary images, edge maps, or motion history images, which capture the dynamic aspects of the silhouette over time. Classification algorithms, including machine learning techniques like SVMs and deep learning models such as CNNs, are then used to compare the extracted features with a datastore of known silhouettes to identify the individual. Silhouette recognition is widely used in security and surveillance, human-computer interaction, and animation, offering a non-intrusive and effective means of identification.

If the data 910 includes a visual representation 910A such as an illustration, the system can perform illustration recognition to identify the first multiplicity of key features 920. Recognizing people from illustrations involves identifying individuals based on artistic representations rather than photographs or real-life images. This process leverages the unique features and stylistic elements that artists use to depict people, such as facial features, body proportions, and distinctive attributes like hairstyles or clothing. The recognition process begins with the acquisition of the illustration, which can be in various forms such as sketches, cartoons, or digital art. Preprocessing steps are applied to enhance the quality of the illustration and standardize it for analysis. Key features are then extracted, focusing on both the geometric aspects (such as the shape of the face, eyes, nose, and mouth) and the stylistic elements (such as line thickness, shading, and color patterns). These features are represented in a form that can be used for comparison, often involving the creation of feature vectors or descriptors that encapsulate the unique characteristics of the illustration. Advanced classification algorithms, including machine learning techniques like SVMs and deep learning models such as CNNs, are employed to compare the extracted features with a datastore of known illustrations to identify the individual. Recognizing people from illustrations is particularly useful in fields such as digital forensics, animation, and art history, where it can help in identifying subjects of artistic works or matching illustrations to real-life individuals.

If the data 910 includes an audio representation 910B, the system can perform voice recognition to identify the first multiplicity of key features 920. Recognizing people from their voice, known as voice or speaker recognition, is a biometric technique that identifies individuals based on the unique characteristics of their vocal patterns. This process leverages the distinct features of a person's voice, such as pitch, tone, cadence, and accent, which are influenced by physiological factors like the shape of the vocal tract and behavioral factors like speaking style. The recognition process begins with the acquisition of voice samples, which can be recorded through microphones or telecommunication devices. These samples undergo preprocessing to enhance quality, including noise reduction and normalization of volume levels. Key features are then extracted from the voice signal, focusing on aspects such as frequency, amplitude, and temporal patterns. Commonly used features include Mel-Frequency Cepstral Coefficients (MFCC), which capture the power spectrum of the voice, and Linear Predictive Coding (LPC), which models the vocal tract. These features are represented in a form suitable for comparison, often as feature vectors. Advanced classification algorithms, including machine learning techniques like Gaussian Mixture Models (GMM) and deep learning models such as Recurrent Neural Networks (RNN), are employed to compare the extracted features with a datastore of known voice samples to identify the individual. Voice recognition is widely used in security systems, customer service, and forensic investigations, offering a non-intrusive and convenient means of identification.

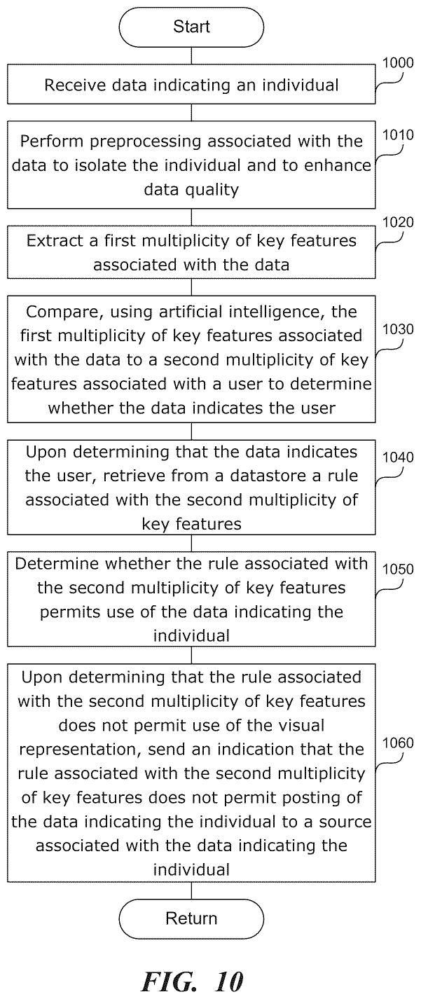

FIG. 10 is a flowchart of a method to identify unauthorized use of digital content. A hardware or software processor executing instructions described in this application can in step 1000 receive data indicating an individual and an indication of use associated with the data. The data can include at least one of: a visual representation, an audio representation, or a walking sequence, as described in this application. Each of the representations can have multiple instances representing the individual. For example, the audio presentation can include an audio of the person as a baby, an audio of the person as a teenager, an audio of the person as a senior, and/or an audio the person after a gender transition. The indication of use can include the source using the representation and how the representation is used. For example, the source can be identified using a unique identifier including a web address, a phone number, an email, and/or a name, and the use can include providing the representation, distributing the representation, etc.

In step 1010, the processor can perform preprocessing associated with the data to isolate the individual and to enhance data quality. The exact type of processing depends on the type of data received, as described in this application.

In step 1020, the processor can extract a first multiplicity of key features associated with the data, where the first multiplicity of key features tend to uniquely identify the individual. The first multiplicity of key features can include at least two of: a body structure, a limb movement, a walking speed, a shape, a contour, a motion, a facial feature, a body proportion, a hairstyle, a clothing, a pitch, a tone, a cadence, or an accent.

In step 1030, the processor can compare, using artificial intelligence, the first multiplicity of key features associated with the data to a second multiplicity of key features associated with a user to determine whether the data indicates the user.

In step 1040, upon determining that the data indicates the user, the processor can retrieve from a datastore a rule associated with the second multiplicity of key features. In step 1050, the processor can determine whether the rule associated with the second multiplicity of key features permits use of the data indicating the individual.

In step 1060, upon determining that the rule associated with the second multiplicity of key features does not permit use of the visual representation, the processor can send an indication that the rule associated with the second multiplicity of key features does not permit the use of the data indicating the individual to a source associated with the data indicating the individual. The indication can include a desired action such as the takedown of the data and/or a request payment.

The processor can receive, from a video camera, a depth sensor, or a wearable device, the data indicating the individual including the walking sequence including a gait cycle. A gait cycle is the repeated pattern of movements, such as foot movements, that occur when someone walks. The walking sequence can include multiple gait cycles. The processor can extract the first multiplicity of key features by analyzing joint angles associated with a walking sequence and limb movements associated with the walking sequence or analyzing a silhouette shape associated with the walking sequence and motion associated with the walking sequence. The processor can represent the first multiplicity of key features using Gait Energy Images (GEI) or Gait Entropy Images (GEnI), where the GEI and GEnI are configured to encapsulate the walking sequence over the gait cycle. The processor can compare, using artificial intelligence, the first multiplicity of key features associated with the data to a second multiplicity of key features associated with the user to determine whether the data indicates the user. The artificial intelligence includes Support Vector Machines (SVM) or Convolutional Neural Networks (CNN).

The processor can receive, from a video camera or a depth sensor, the data indicating the individual comprising the visual representation including a silhouette associated with the individual. The processor can perform preprocessing associated with the data including: subtracting a background from the data indicating the individual to isolate the individual, and performing noise reduction to enhance the quality of the data. The processor can extract the first multiplicity of key features including the shape, the contour, and the motion of the silhouette. The processor can represent the first multiplicity of key features using a binary image, an edge map, or multiple motion history images, where the multiple motion history images capture the silhouette over time. The processor can compare, using artificial intelligence, the first multiplicity of key features associated with the data to a second multiplicity of key features associated with the user to determine whether the data indicates the user. The artificial intelligence can include SVMs or CNNs.

The processor can receive the data indicating the individual comprising the visual representation including an illustration associated with the individual. The processor can extract the first multiplicity of key features including the facial feature, the body proportion, the hairstyle, and the clothing. The processor can represent the first multiplicity of key features by creating multiple feature vectors representing the first multiplicity of key features. Multiple feature vectors can be created using various techniques such as Scale-Invariant Feature Transform (SIFT), Histogram of Oriented Gradients (HOG), or CNNs. These methods help in identifying key points and patterns in the image that are distinctive and invariant to changes in scale, rotation, or lighting. The processor can compare, using artificial intelligence, the first multiplicity of key features associated with the data to a second multiplicity of key features associated with the user to determine whether the data indicates the user. The artificial intelligence includes SVMs or CNNs.

The processor can receive, from a telecommunication device, the data indicating the individual including the audio representation associated with the individual. The processor can perform preprocessing associated with the data including noise reduction and normalization of volume levels. The processor can extract the first multiplicity of key features including the frequency, amplitude, and temporal patterns. The processor can represent the first multiplicity of key features by creating multiple feature vectors representing the first multiplicity of key features, where the multiple feature vectors include Mel-Frequency Cepstral Coefficients (MFCC) indicating the power spectrum of the voice and Linear Predictive Coding (LPC) indicating the vocal tract. The processor can compare, using artificial intelligence, the first multiplicity of key features associated with the data to a second multiplicity of key features associated with the user to determine whether the data indicates the user. The artificial intelligence includes Gaussian Mixture Models (GMM) or Recurrent Neural Networks (RNN).

Upon determining that the rule associated with the second multiplicity of key features permits the use of the visual representation, the processor can increase a first indicator in the datastore, where the first indicator indicates a number of times the rule associated with the second multiplicity of key features is found to permit the use. Upon determining that the rule associated with the second multiplicity of key features does not permit the use of the visual representation, the processor can increase a second indicator in the datastore, where the second indicator indicates a number of times the rule associated with the second multiplicity of key features is found not to permit the use. The processor can obtain from the datastore multiple codes associated with multiple responses. Upon determining that the rule associated with the second multiplicity of key features does not permit the use of the visual representation, the processor can send the indication that the rule associated with the second multiplicity of key features does not permit the use of the visual representation to the source associated with the visual representation. The indication can include one or more of the multiple codes and an invitation to respond using the one or more of the multiple codes. The processor can receive a response from the source associated with the visual representation, where the response includes the one or more of the multiple codes. The processor can store the received one or more of the multiple codes in the datastore.

The processor can receive the data indicating the individual including an image or a video. The processor can perform preprocessing to enhance quality and reduce noise and can extract the first multiplicity of key features including the eyes, nose, mouth, and the overall facial contour using algorithms such as Haar cascades or deep learning models like CNNs. The processor can represent the first multiplicity of key features by creating multiple feature vectors representing the first multiplicity of key features. When the data includes the video, the processor can track the individual's face across multiple frames associated with the video. The processor can compare, using artificial intelligence, the first multiplicity of key features associated with the data to a second multiplicity of key features associated with the user to determine whether the data indicates the user.

### Computer System

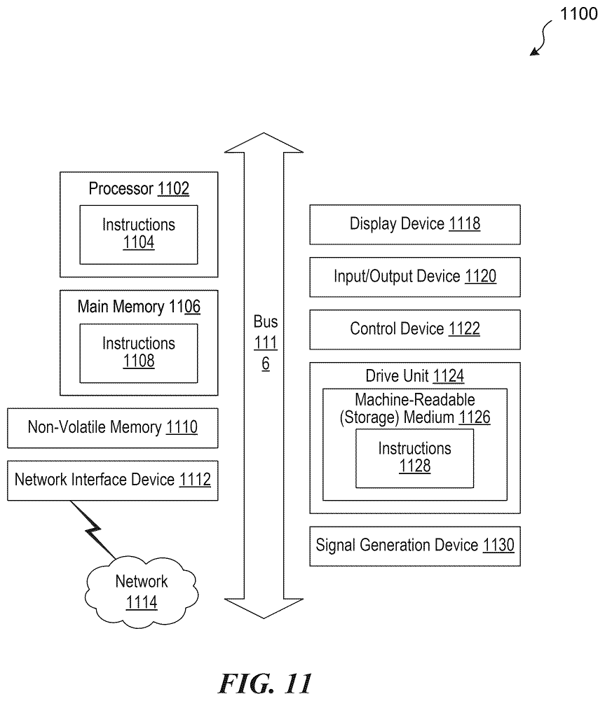

FIG. 11 is a block diagram that illustrates an example of a computer system 1100 in which at least some operations described herein can be implemented. As shown, the computer system 1100 can include: one or more processors 1102, main memory 1106, non-volatile memory 1110, a network interface device 1112, a display device 1118, an input/output device 1120, a control device 1122 (e.g., keyboard and pointing device), a drive unit 1124 that includes a machine-readable (storage) medium 1126, and a signal generation device 1130 that are communicatively connected to a bus 1116. The bus 1116 represents one or more physical buses and/or point-to-point connections that are connected by appropriate bridges, adapters, or controllers. Various common components (e.g., cache memory) are omitted from FIG. 11 for brevity. Instead, the computer system 1100 is intended to illustrate a hardware device on which components illustrated or described relative to the examples of the Figures and any other components described in this specification can be implemented.

The computer system 1100 can take any suitable physical form. For example, the computer system 1100 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 1100. In some implementations, the computer system 1100 can be an embedded computer system, a system-on-chip (SOC), a single-board computer (SBC) system, or a distributed system such as a mesh of computer systems or include one or more cloud components in one or more networks. Where appropriate, one or more computer systems 1100 can perform operations in real time, near real time, or in batch mode.

The network interface device 1112 enables the computer system 1100 to mediate data in a network 1114 with an entity that is external to the computer system 1100 through any communication protocol supported by the computer system 1100 and the external entity. Examples of the network interface device 1112 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1106, non-volatile memory 1110, machine-readable (storage) medium 1126) can be local, remote, or distributed. Although shown as a single medium, the machine-readable (storage) medium 1126 can include multiple media (e.g., a centralized/distributed database and/or associated caches and servers) that store one or more sets of instructions 1128. The machine-readable (storage) medium 1126 can include any medium that is capable of storing, encoding, or carrying a set of instructions for execution by the computer system 1100. The machine-readable (storage) medium 1126 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1110, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1104, 1108, 1128) set at various times in various memory and storage devices in computing device(s). When read and executed by the processor 1102, the instruction(s) cause the computer system 1100 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the system. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the system, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the system should not be taken to imply that the terminology is being redefined herein to be restricted to any specific characteristics, features, or aspects of the system with which that terminology is associated. In general, the terms used in the following claims should not be construed to limit the system to the specific examples disclosed herein, unless the Detailed Description above explicitly defines such terms. Accordingly, the actual scope of the system encompasses not only the disclosed examples but also all equivalent ways of practicing or implementing the system under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the system can be modified to employ the systems, functions, and concepts of the various references described above to provide yet further implementations of the system.

To reduce the number of claims, certain implementations are presented below in certain claim forms, but the applicant contemplates various aspects of a system in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A non-transitory, computer-readable storage medium comprising instructions recorded thereon, wherein the instructions, when executed by at least one data processor of a system, cause the system to:
receive data indicating an individual and an indication of use associated with the data,
wherein the data indicating the individual includes at least two of: a visual representation, an audio representation, or a walking sequence;
perform preprocessing associated with the data indicating the individual to isolate the individual and to enhance the quality of the data indicating the individual;
extract a first multiplicity of key features associated with the data indicating the individual,
wherein the first multiplicity of key features tend to uniquely identify the individual, and
wherein the first multiplicity of key features include at least four of: a body structure, a limb movement, a walking speed, a shape, a contour, a motion, a facial feature, a body proportion, a hairstyle, a clothing, a pitch, a tone, a cadence, or an accent;
compare, using artificial intelligence, the first multiplicity of key features associated with the data indicating the individual to a second multiplicity of key features associated with a user to determine whether the data indicates the user;
upon determining that the data indicates the user, retrieve from a datastore a rule associated with the second multiplicity of key features;
determine whether the rule associated with the second multiplicity of key features permits the use of the data indicating the individual; and
upon determining that the rule associated with the second multiplicity of key features does not permit the use of the visual representation, send an indication that the rule associated with the second multiplicity of key features does not permit the use of the data indicating the individual to a source associated with the data indicating the individual.

2. The non-transitory, computer-readable storage medium of claim 1, comprising instructions to:
receive, from a video camera, a depth sensor, or a wearable device, the data indicating the individual including the walking sequence,
wherein the walking sequence includes a gait cycle;
extract the first multiplicity of key features by analyzing joint angles associated with the walking sequence and limb movements associated with the walking sequence or analyzing a silhouette shape associated with the walking sequence and a motion associated with the walking sequence;
represent the first multiplicity of key features using Gait Energy Images (GEI) or Gait Entropy Images (GEnI),
wherein the GEI and the GEnI are configured to encapsulate the walking sequence over the gait cycle; and
compare, using the artificial intelligence, the first multiplicity of key features associated with the data indicating the individual to the second multiplicity of key features associated with the user to determine whether the data indicates the user,
wherein the artificial intelligence includes Support Vector Machines or Convolutional Neural Networks (CNN).

3. The non-transitory, computer-readable storage medium of claim 1, comprising instructions to:
receive, from a video camera or a depth sensor, the data indicating the individual comprising the visual representation including a silhouette associated with the individual;
perform preprocessing associated with the data indicating the individual including:
subtracting a background from the data indicating the individual to isolate the individual; and
performing noise reduction to enhance the quality of the data indicating the individual;
extract the first multiplicity of key features including the shape, the contour, and the motion of the silhouette;
represent the first multiplicity of key features using a binary image, an edge map, or multiple motion history images,
wherein the multiple motion history images capture the silhouette over time; and
compare, using the artificial intelligence, the first multiplicity of key features associated with the data indicating the individual to the second multiplicity of key features associated with the user to determine whether the data indicates the user,
wherein the artificial intelligence includes Support Vector Machines or CNNs.

4. The non-transitory, computer-readable storage medium of claim 1, comprising instructions to:
receive the data indicating the individual comprising the visual representation including an illustration associated with the individual;
extract the first multiplicity of key features including the facial feature, the body proportion, the hairstyle, and the clothing;
represent the first multiplicity of key features by creating multiple feature vectors representing the first multiplicity of key features; and
compare, using the artificial intelligence, the first multiplicity of key features associated with the data indicating the individual to the second multiplicity of key features associated with the user to determine whether the data indicates the user,
wherein the artificial intelligence includes Support Vector Machines or CNNs.

5. The non-transitory, computer-readable storage medium of claim 1, comprising instructions to:
receive the data indicating the individual including the audio representation associated with the individual;
perform preprocessing associated with the data indicating the individual including noise reduction and normalization of volume levels;
extract the first multiplicity of key features including a frequency, an amplitude, and temporal patterns;
represent the first multiplicity of key features by creating multiple feature vectors representing the first multiplicity of key features,
wherein the multiple feature vectors include Mel-Frequency Cepstral Coefficients (MFCC) indicating a power spectrum of a voice and Linear Predictive Coding (LPC) indicating a vocal tract; and
compare, using the artificial intelligence, the first multiplicity of key features associated with the data indicating the individual to the second multiplicity of key features associated with the user to determine whether the data indicates the user,
wherein the artificial intelligence includes Gaussian Mixture Models or Recurrent Neural Networks.

6. The non-transitory, computer-readable storage medium of claim 1, comprising instructions to:
upon determining that the rule associated with the second multiplicity of key features permits the use of the visual representation, increase a first indicator in the datastore,
wherein the first indicator indicates a number of times the rule associated with the second multiplicity of key features is found to permit the use;
upon determining that the rule associated with the second multiplicity of key features does not permit the use of the visual representation, increase a second indicator in the datastore,
wherein the second indicator indicates a number of times the rule associated with the second multiplicity of key features is found not to permit the use;
obtain, from the datastore, multiple codes associated with multiple responses;
upon determining that the rule associated with the second multiplicity of key features does not permit the use of the visual representation, send the indication that the rule associated with the second multiplicity of key features does not permit the use of the visual representation to the source associated with the visual representation,
wherein the indication includes one or more of the multiple codes and an invitation to respond using the one or more of the multiple codes;
receive a response from the source associated with the visual representation, wherein the response includes the one or more of the multiple codes; and
store the received one or more of the multiple codes in the datastore.

7. The non-transitory, computer-readable storage medium of claim 1, comprising instructions to:
receive the data indicating the individual including an image or a video;
perform preprocessing to enhance quality and reduce noise;
extract the first multiplicity of key features including eyes, nose, mouth, and overall facial contour;
represent the first multiplicity of key features by creating multiple feature vectors representing the first multiplicity of key features;
when the data includes the video, track the individual's face across multiple frames associated with the video; and
compare, using the artificial intelligence, the first multiplicity of key features associated with the data indicating the individual to the second multiplicity of key features associated with the user to determine whether the data indicates the user.

8. A method comprising:
receiving data indicating an individual;
performing preprocessing associated with the data indicating the individual to isolate the individual and to enhance the quality of the data indicating the individual;
extracting a first multiplicity of key features associated with the data indicating the individual,
wherein the first multiplicity of key features tend to uniquely identify the individual, and
wherein the first multiplicity of key features include at least two of: a body structure, a limb movement, a walking speed, a shape, a contour, a motion, a facial feature, a body proportion, a hairstyle, a clothing, a pitch, a tone, a cadence, or an accent;
comparing, using artificial intelligence, the first multiplicity of key features associated with the data indicating the individual to a second multiplicity of key features associated with a user to determine whether the data indicates the user;
upon determining that the data indicates the user, retrieving from a datastore a rule associated with the second multiplicity of key features;
determining whether the rule associated with the second multiplicity of key features permits a use of the data indicating the individual; and
upon determining that the rule associated with the second multiplicity of key features does not permit the use of the data indicating the individual, sending an indication that the rule associated with the second multiplicity of key features does not permit the use of the data indicating the individual to a source associated with the data indicating the individual.

9. The method of claim 8, comprising:
receiving, from a video camera, a depth sensor, or a wearable device, the data indicating the individual including a walking sequence,
wherein the walking sequence includes a gait cycle;
extracting the first multiplicity of key features by analyzing joint angles associated with the walking sequence and limb movements associated with the walking sequence or analyzing a silhouette shape associated with the walking sequence and motion associated with the walking sequence;
representing the first multiplicity of key features using Gait Energy Images (GEI) or Gait Entropy Images (GEnI),
wherein the GEI and the GEnI are configured to encapsulate the walking sequence over the gait cycle; and
comparing, using the artificial intelligence, the first multiplicity of key features associated with the data indicating the individual to the second multiplicity of key features associated with the user to determine whether the data indicates the user,
wherein the artificial intelligence includes Support Vector Machines or Convolutional Neural Networks (CNN).

10. The method of claim 8, comprising:
receiving, from a video camera or a depth sensor, the data indicating the individual comprising a visual representation including a silhouette associated with the individual;
performing preprocessing associated with the data indicating the individual including:
subtracting a background from the data indicating the individual to isolate the individual; and
performing noise reduction to enhance the quality of the data indicating the individual;
extracting the first multiplicity of key features including the shape, the contour, and the motion of the silhouette;
representing the first multiplicity of key features using a binary image, an edge map, or multiple motion history images,
wherein the multiple motion history images capture the silhouette over time;
comparing, using the artificial intelligence, the first multiplicity of key features associated with the data indicating the individual to the second multiplicity of key features associated with the user to determine whether the data indicates the user,
wherein the artificial intelligence includes Support Vector Machines or CNNs.

11. The method of claim 8, comprising:
receiving the data indicating the individual comprising a visual representation including an illustration associated with the individual;
extracting the first multiplicity of key features including the facial feature, the body proportion, the hairstyle, and the clothing;
representing the first multiplicity of key features by creating multiple feature vectors representing the first multiplicity of key features; and
comparing, using the artificial intelligence, the first multiplicity of key features associated with the data indicating the individual to the second multiplicity of key features associated with the user to determine whether the data indicates the user,
wherein the artificial intelligence includes Support Vector Machines or CNNs.

12. The method of claim 8, comprising:
receiving, from a telecommunication device, the data indicating the individual including an audio representation associated with the individual;
performing preprocessing associated with the data indicating the individual including noise reduction and normalization of volume levels;
extracting the first multiplicity of key features including a frequency, an amplitude, and temporal patterns;
representing the first multiplicity of key features by creating multiple feature vectors representing the first multiplicity of key features,
wherein the multiple feature vectors include Mel-Frequency Cepstral Coefficients (MFCC) indicating a power spectrum of a voice and Linear Predictive Coding (LPC) indicating a vocal tract; and
comparing, using the artificial intelligence, the first multiplicity of key features associated with the data indicating the individual to the second multiplicity of key features associated with the user to determine whether the data indicates the user,
wherein the artificial intelligence includes Gaussian Mixture Models or Recurrent Neural Networks.

13. The method of claim 8, comprising:
upon determining that the rule associated with the second multiplicity of key features permits the use of the data indicating the individual, increasing a first indicator in the datastore,
wherein the first indicator indicates a number of times the rule associated with the second multiplicity of key features is found to permit the use;
upon determining that the rule associated with the second multiplicity of key features does not permit the use of the data indicating the individual, increasing a second indicator in the datastore,
wherein the second indicator indicates a number of times the rule associated with the second multiplicity of key features is found not to permit the use;
obtaining, from the datastore, multiple codes associated with multiple responses;
upon determining that the rule associated with the second multiplicity of key features does not permit the use of the data indicating the individual, sending the indication that the rule associated with the second multiplicity of key features does not permit the use of the data indicating the individual to the source associated with the data indicating the individual,
wherein the indication includes one or more of the multiple codes and an invitation to respond using the one or more of the multiple codes;
receiving a response from the source associated with the data indicating the individual,
wherein the response includes the one or more of the multiple codes; and
storing the received one or more of the multiple codes in the datastore.

14. A system comprising:
at least one hardware processor; and
at least one non-transitory memory storing instructions, which, when executed by the at least one hardware processor, cause the system to:
receive data indicating an individual;
perform preprocessing associated with the data indicating the individual to isolate the individual and to enhance the quality of the data indicating the individual;
extract a first multiplicity of key features associated with the data indicating the individual,
wherein the first multiplicity of key features tend to uniquely identify the individual,
wherein the first multiplicity of key features include at least two of: a body structure, a limb movement, a walking speed, a shape, a contour, a motion, a facial feature, a body proportion, a hairstyle, a clothing, a pitch, a tone, a cadence, or an accent;
compare, using artificial intelligence, the first multiplicity of key features associated with the data indicating the individual to a second multiplicity of key features associated with a user to determine whether the data indicates the user;
upon determining that the data indicates the user, retrieve from a datastore a rule associated with the second multiplicity of key features;
determine whether the rule associated with the second multiplicity of key features permits a use of the data indicating the individual; and
upon determining that the rule associated with the second multiplicity of key features does not permit the use of the data indicating the individual, send an indication that the rule associated with the second multiplicity of key features does not permit the use of the data indicating the individual to a source associated with the data indicating the individual.

15. The system of claim 14, comprising instructions to:
receive, from a video camera, a depth sensor, or a wearable device, the data indicating the individual including a walking sequence,
wherein the walking sequence includes a gait cycle;
extract the first multiplicity of key features by analyzing joint angles associated with the walking sequence and limb movements associated with the walking sequence or analyzing a silhouette shape associated with the walking sequence and motion associated with the walking sequence;
represent the first multiplicity of key features using Gait Energy Images (GEI) or Gait Entropy Images (GEnI),
wherein the GEI and the GEnI are configured to encapsulate the walking sequence over the gait cycle; and
compare, using the artificial intelligence, the first multiplicity of key features associated with the data indicating the individual to the second multiplicity of key features associated with the user to determine whether the data indicates the user,
wherein the artificial intelligence includes Support Vector Machines or Convolutional Neural Networks (CNN).

16. The system of claim 14, comprising instructions to:
receive, from a video camera or a depth sensor, the data indicating the individual comprising a visual representation including a silhouette associated with the individual;
perform preprocessing associated with the data indicating the individual including:
subtracting a background from the data indicating the individual to isolate the individual; and
performing noise reduction to enhance the quality of the data indicating the individual;
extract the first multiplicity of key features including the shape, the contour, and the motion of the silhouette;
represent the first multiplicity of key features using a binary image, an edge map, or multiple motion history images,
wherein the multiple motion history images capture the silhouette over time; and
compare, using the artificial intelligence, the first multiplicity of key features associated with the data indicating the individual to the second multiplicity of key features associated with the user to determine whether the data indicates the user,
wherein the artificial intelligence includes Support Vector Machines or CNNs.

17. The system of claim 14, comprising instructions to:
receive the data indicating the individual comprising a visual representation including an illustration associated with the individual;
extract the first multiplicity of key features including the facial feature, the body proportion, the hairstyle, and the clothing;
represent the first multiplicity of key features by creating multiple feature vectors representing the first multiplicity of key features; and
compare, using the artificial intelligence, the first multiplicity of key features associated with the data indicating the individual to the second multiplicity of key features associated with the user to determine whether the data indicates the user,
wherein the artificial intelligence includes Support Vector Machines or CNNs.

18. The system of claim 14, comprising instructions to:
receive the data indicating the individual including an audio representation associated with the individual;
perform preprocessing associated with the data indicating the individual including noise reduction and normalization of volume levels;
extract the first multiplicity of key features including a frequency, an amplitude, and temporal patterns;
represent the first multiplicity of key features by creating multiple feature vectors representing the first multiplicity of key features,
wherein the multiple feature vectors include Mel-Frequency Cepstral Coefficients (MFCC) indicating a power spectrum of voice and Linear Predictive Coding (LPC) indicating a vocal tract; and
compare, using the artificial intelligence, the first multiplicity of key features associated with the data indicating the individual to the second multiplicity of key features associated with the user to determine whether the data indicates the user,
wherein the artificial intelligence includes Gaussian Mixture Models or Recurrent Neural Networks.

19. The system of claim 14, comprising instructions to:
upon determining that the rule associated with the second multiplicity of key features permits the use of the data indicating the individual, increase a first indicator in the datastore,
wherein the first indicator indicates a number of times the rule associated with the second multiplicity of key features is found to permit the use;
upon determining that the rule associated with the second multiplicity of key features does not permit the use of the data indicating the individual, increase a second indicator in the datastore,
wherein the second indicator indicates a number of times the rule associated with the second multiplicity of key features is found not to permit the use;
obtain, from the datastore, multiple codes associated with multiple responses;
upon determining that the rule associated with the second multiplicity of key features does not permit the use of the data indicating an individual, send the indication that the rule associated with the second multiplicity of key features does not permit the use of the data indicating the individual to the source associated with the data,
wherein the indication includes one or more of the multiple codes and an invitation to respond using the one or more of the multiple codes;
receive a response from the source associated with the data indicating the individual,
wherein the response includes the one or more of the multiple codes; and
store the received one or more of the multiple codes in the datastore.

20. The system of claim 14, comprising instructions to:
receive the data indicating the individual including an image or a video;
perform preprocessing to enhance quality and reduce noise;
extract the first multiplicity of key features including eyes, nose, mouth, and overall facial contour;
represent the first multiplicity of key features by creating multiple feature vectors representing the first multiplicity of key features;
when the data indicating the individual includes the video, track the individual's face across multiple frames associated with the video; and
compare, using the artificial intelligence, the first multiplicity of key features associated with the data indicating the individual to the second multiplicity of key features associated with the user to determine whether the data indicates the user.
